(19) United States
(12) Patent Application Publication
(10) Pub. No.: US 2010/0194287 A1
(43) Pub. Date: Aug. 5, 2010

(54) ELECTRONIC BALLAST FOR A HIGH INTENSITY DISCHARGE LAMP

(76) Inventors: Roberto Vivero-Flores, Morelos (MX); Alberto Manuel Campos-Violante, Morelos (MX)

Correspondence Address: BROWDY AND NEIMARK, P.L.L.C.;624 NINTH STREET, NW, SUITE 300, WASHINGTON, DC, 20001-5303, US

(21) Appl. No.: 12/525,634

(22) PCT Filed: Jan. 29, 2008
(86) PCT No.: PCT/IB08/00232

§ 371 Date: Apr. 12, 2010

(30) Foreign Application Priority Data
Feb. 1, 2007 (MX) MX/A/2007/001317

(51) Int. Cl. H05B 41/26

(52) U.S. Cl. 315/149; 315/247; 315/160

(57) ABSTRACT

An electronic ballast for an HID lamp is described, comprising: a rectifier circuit; a PFC power factor correction circuit increasing the direct current (DC) voltage coming out from the rectifier circuit; a current converter receiving the high voltage DC and converts it to alternating current (AC) to be supplied to the lamp; an ignition circuit generating ignition pulses being fed to the converter circuit to turn on the lamp, the pulses are generated by a downward frequencies scan, and, a control circuit commanding the operation of the ignition circuit and controlling the power being supplied to the lamp according to a power profile being determined by the lightning conditions desired to be obtained from said lamp to save energy. The operative method for the ballast is also described.

### FIELD OF THE INVENTION

The present invention relates to the techniques employed in the design of electric and electronic devices to operate lamps and, more specifically, relates to electronic ballasts for high-intensity discharge (HID) lamps that incorporate a control circuit that controls the lamp according to an user-defined power profile with the purpose of saving energy.

### BACKGROUND OF THE INVENTION

The term “high-intensity discharge” (HID), is employed to describe any lighting system that makes use of an arc lamp filled up with gas. These lamps are classified according to the type of gas contained therein, such as mercury, sodium, and so on.

The electric arc generated between the two main electrodes of an HID lamp can be viewed as a short circuit that can be maintained indefinitely. Once sufficient voltage inside the lamp exists, the gases are ionized to the point that they can conduct the current themselves. In this regard, it is widely known that the formation of the arc is not an immediate process, turning on the lamp can take several seconds in order to generate the arc and a few minutes more to warm up the lamp and reach its lighting peak.

HID lamps are negative impedance devices, i.e. unless they are controlled, the current would increase, thereby causing the lamp to fail almost instantly after being turned on. Due to the latter, each HID lamp requires the use of a ballast, which is a current-limiting device. A ballast hast three main functions, which are i) providing the proper voltage to turn on the lamp; ii) supplying the proper voltage to run the lamp; and iii) restricting the lamp current to a preset level in order to avoid damages thereto.

HID lamps are employed in many applications, the main use being public lighting and illumination of spaces where the roof is located considerably higher with respect to people or objects on the floor, as these HID lamps offer a better illumination over greater distances versus fluorescent lamps.

HID lamps functioned by means of ferromagnetic ballasts for a long time which showed a significant waste of energy; however, thanks to the progress in electronics and in integrated circuits, electronic ballast have been developing with a reduced weight than that of traditional ferromagnetic ballasts, and above all, electronics ballasts have been designed to allow a more reliable turn on of the lamp and therefore to decrease energy waste. In addition, electronic ballasts known to date also allow the possibility to modify the power supplied to the lamp for the luminous emission thereof at will and in a controlled manner, i.e., “DIMMING”.

One example of electronic ballast can be found in U.S. Pat. No. 6,707,263 B1, which discloses a ballast designed to operate lighting networks consisting of HID lamps, wherein any broken-down lamp must be replaced. Furthermore, U.S. Pat. No. 6,841,951 B2 discloses an electronic ballast configured in a single operation step, thereby reducing electronic components and devices.

An additional example of electronic ballast is disclosed in US patent application No. US/2006/017593, which refers to an electronic ballast wherein DIMMING is controlled by means of software. Similarly, U.S. Pat. No. 7,049,768 B1 also provides a ballast wherein DIMMING is electronically controlled so that the color of light emitted by the lamp is adequate.

On the other hand, it is convenient to mention that, traditionally, the light intensity emitted by HID lamps for public lighting and those used at industrial facilities keeps constant after warming up of the lamp and until the lamp is turned off, generally at dawn.

Nevertheless, this traditional operation represents a waste of energy since, as it is known, passage of people and vehicles is intense during the first hours in the evening and some hours before sunrise, yet scarce throughout the rest of the night. Few ballasts and devices have taken this fact into consideration, i.e., HID lamps running at 100% of their lighting capacity all night long is not necessary. From another point of view, it has not been foreseen that, at certain hours in the night, HID lamps could emit their light at a reduced capacity yet still complying with the set illumination limits. This would naturally bring about energy savings, especially for public lighting systems, and economizing money to authorities and, ultimately, to tax payers.

In international patent application PCT/MX2003/000079 an energy saving device is disclosed, which use is restricted to sodium steam lamps, and therefore represents a drawback because other types of HID lamps are used in public lighting and in other day-to-day applications. Generally speaking, energy saving proposed by said document is conditioned to the following: 1) the use of a discharge lamp with a high luminous efficiency, particularly, a high luminous efficiency sodium steam lamp; 2) the use of a highly-efficient electronic ballast with an elevated power factor that turns on the lamp without the need of an additional igniter; and, c) an operating method that consists of the reduction of luminous intensity provided to the lamp late in the night.

In order to achieve such energy saving, the device simply dims the luminous intensity of the lamp by changing the operating point thereof during a preset time late in the night. Of course, a major drawback of this ballast is that duration of days and nights is not constant throughout the year in various latitudes of the world, and hence, energy saving achieved by this device is not optimal.

The device of PCT '079, is made on a rather traditional topology of circuits, and as mentioned, energy saving is limited to the temporary reduction of the luminous flux of said sodium steam lamp.

Furthermore, throughout the functioning of the PCT '079 device, its frequency of operation closely resembles that of the acoustic resonance frequency of the resonant circuit and therefore occurrence thereof is sought to avoid. For that reason, the device uses a technique well known in the art that is the operating frequency modulation of the inverter circuit. In this regard, it should not be forgotten as well that sodium steam lamps display this acoustic resonance phenomenon in a well-defined range of frequencies, therefore the effort to conduct the modulation technique and decrease the lamp's luminous intensity to save energy seems trivial.

Additionally, in order to detect day and night periods, the PCT '079 device makes use of a rather conventional current transformer connected to a microprocessor that orders the turn on, for ignition a frequencies scan of +−5% around the ignition frequency is used, so in case the lamp is not turned on, a turn off action from the inverter is required to avoid damage of the lamp.

The PCT '079 device, was slightly modified in the Mexican patent application PA/a/MX2005/011674 in order to provide the same with an output power measurement that offsets voltage variations that take place due to ageing of the lamp and/or heating thereof with the purpose of achieving the programmed energy saving in the microprocessor. Nevertheless, despite this modification, the device of application '674 does not optimize energy saving, i.e., it is restricted because attenuations in luminous intensity are of a fixed nature, and furthermore, its use is remarkably conditioned to high luminic efficiency sodium steam lamps.

As mentioned, there are locations in certain latitudes of the earth wherein night duration varies between seasons, and especially in winter, the night duration is particularly long, such that public lighting systems waste energy by functioning at full illumination capacity throughout the night, energy that could be better exploited for other uses, i.e., heating, the latter has not come to fruition due to the fact that having a centralized control to run a wide network of HID lamps would result in a large investment thereon. Operation of the lamp would become even more efficient if it is considered that sunrise and sunset times in a determined place varies from one day to another.

Therefore, there exists the necessity of a ballast for HID lamps that meets this operation need according to a user-defined power profile, and which operation takes place preferably in a self-contained way in each lamp. Additionally, maximizing the useful life of the HID lamp concerned by means of a reliable turn on, operation and turn off thereof must be sought.

### SUMMARY OF THE INVENTION

Pursuant to the above, the drawbacks of prior-art electronic ballasts have been left out by developing an electronic ballast for a high intensity discharge lamp, which operation follows a user-defined preset power profile to save energy. The electronic ballast of the present invention comprises a series of interconnected circuits that work in a particular form, namely, there exists one rectifier circuit that receives alternating current (AC) from an alternating current source and converts the same into direct current (DC); one power factor correction (PFC) circuit that increases the voltage direct current (DC) coming out from such rectifier circuit and reduces the total harmonic distortion; one current converter circuit that receives the high-voltage direct current (DC) coming out from the power factor correction circuit and converts it into high- or low frequency alternating current (AC), which is supplied to the high intensity discharge lamp intended for operation.

Furthermore, in the ballast of the present invention, there exists one ignition circuit that generates ignition pulses that are fed to the current converter circuit to turn on the lamp, the ignition pulses being generated according to a downward frequencies scan to a fraction of the lamp's nominal power to ensure the turn on thereof; and, finally, there exists one control circuit in connection with the ignition circuit and the DC to AC converter circuit, wherein the control circuit starts the operation of the ignition circuit to turn on the lamp and also controls the power being supplied to the lamp from its turn on to its turn off, according to a power profile stored in the control circuit and determined by the lighting conditions that the user wishes to obtain from such lamp in order to save energy.

In another ballast embodiment, it includes one auxiliary power supply to feed the controllers and electronic circuits of the power factor correction circuit, the converter circuit, ignition circuit and the control circuit to thereby ensure the operation of the ballast, i.e., ensure that the functions of the ballast can be started and executed whenever they are required.

The power profile comprises a series of steps that last for a determined time, in each step the ballast supplies to the lamp a higher or lower power, the start and end command of each step comes from the control circuit. In a preferred embodiment the duration of the steps does not vary between one night and the following.

In another preferred embodiment, the control circuit comprises one programmable microcontroller with a non-flash memory that stores the functioning time data of the lamp from the turn on to its turn off in one night, said microcontroller automatically adjusts the length of each of the power profile steps to be carried out the following night, something very useful in places where night duration varies from one season to another. Simply put, the ballast learns from the duration of each night.

In one aspect of the invention, one operation method of a ballast for an HID lamp is provided, the operation method comprising the steps of detecting the state of darkness where night begins; afterwards, establishing a power profile that the ballast must supply to the lamp during the night. In this regard, the power profile comprises a series of power steps, each of them having a power value that the ballast must supply to the lamp, as well as a length of time that can be recalculated with the length data of at least one previous night. In order to obtain the length of the steps, the average length of the night is divided into a set number of steps or power segments to which dimming of light intensity will be applied to, thereby reducing the consumption of energy in accordance with the power supplied in the corresponding step. Likewise, it is preferred that the luminous intensity of the lamp be greater during the steps closer to the evening and dawn, and dimmer during intermediate steps of the night.

Once the power profile to be executed by the ballast is set, the method comprises the step of turning the lamp on by means of a downward frequencies scan, the downward scan being conducted from a frequency higher than that of the ignition frequency of the lamp to a heating frequency thereof and executed at a fraction of the nominal power thereof. Once turned on, the lamp is preheated and the power profile steps are executed. Within this method, execution of all the profile steps is also verified and is detected if dawn has arrived, if affirmative the lamp is turned off, and finally the length of the night is estimated so that the value calculated can be stored and taken into consideration to recalculate the length of the power profile steps that the ballast must execute the following night.

In view of the above, it can be mentioned that one object of the present invention is to provide an electronic ballast that allows operation of an HID lamp with energy saving and a reliable turn on.

### BRIEF DESCRIPTION OF THE DRAWINGS

The novelty aspects deemed as unique to the present invention, shall be specifically set forth in the appended claims. Nevertheless, the invention, both in terms of its structure and mode of operation thereof along with other objects and advantages thereof, shall be better understood with the following detailed description of a preferred embodiment, when read in conjunction with the accompanying drawings, and wherein:

FIG. 1 is a block diagram of the circuits comprising an electronic ballast configured according to one preferred embodiment of the present invention.

FIG. 2 is a diagram of the electronic circuits from the electronic ballast in accordance with the block diagram shown in FIG. 1.

FIG. 3 is the diagram of the rectifier circuit and of the power factor correction (PFC) circuit of the electronic ballast of FIG. 2.

FIG. 4 is the diagram of the high- or low frequency direct current to alternating current converter circuit of the electronic ballast of FIG. 2.

FIG. 5 is the diagram of the ignition circuit from the electronic ballast of FIG. 2.

FIG. 6 is the diagram of the control circuit from the electronic ballast of FIG. 2.

FIG. 7 is the diagram of the auxiliary power source circuit of the electronic ballast of FIG. 2.

FIG. 8 is a flow diagram that shows one preferred embodiment of the operation method of an electronic ballast to operate an HID lamp.

FIG. 9 is a typical operation curve of the power profile supplied by the ballast of the present invention to an HID lamp during night operation.

FIG. 10 is a plot that shows the time lapsed during one night and the power percentage supplied by the ballast to an HID lamp.

### DETAILED DESCRIPTION OF THE INVENTION

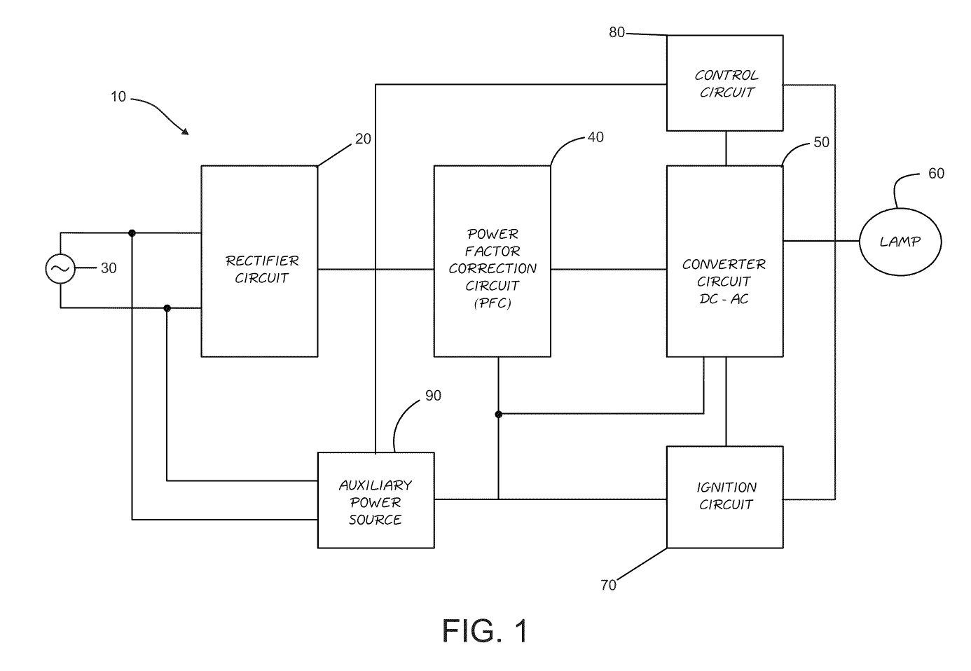

By referring to the accompanying drawings, and more specifically, to FIG. 1 thereof, there is shown one block diagram of an electronic ballast 10 configured according to one preferred embodiment of the present invention, which is to be considered an illustrative rather than a restricting embodiment thereof. The electronic ballast 10 comprises one rectifier circuit 20 that receives alternating current (AC) from an alternating current source 30, for example from the public electricity system and converts it into direct current (DC), which is received by one power factor correction circuit (PFC) 40 that raises the direct current (DC) voltage coming out from said rectifier circuit 20 and reduces the total harmonic distortion.

The high voltage direct current coming out from the power factor correction circuit 40 is received by one high- or low frequency direct current (DC) to alternating current (AC) converter circuit 50, which is supplied towards one high intensity discharge lamp (60) for turn on and operation thereof.

In the block diagram illustrated in FIG. 1, an ignition circuit 70 it is also represented which generates ignition pulses being fed to the converter circuit 50 to turn on the lamp 60, these ignition pulses are generated according to a downward frequencies scan to ensure the turning on of the lamp 60.

An essential part of the electronic ballast 10 is the control circuit 80 which is connected to the ignition circuit 70 and to the converter circuit 50. When the exterior illuminating conditions required to turn on the lamp 60 are detected by the control circuit 80, i.e., when the night begins to fall, said control circuit 80 starts up the ignition circuit 70 operation generating thereby the ignition pulses and turning on the lamp 60. In addition, control circuit 80 controls the power supplied to said lamp 60 from its turning on to its turning off, e.g., at daybreak. The power is supplied to the lamp by means of the control circuit 80 according to a power profile determined by the lightning conditions a user desires to obtain from said lamp during the operation schedule thereof, that is, at nighttime, the circuit may command the lamp to operate at full power or to lower or increase gradually or to maintain its lightning for a determined period of time.

Finally, block 90 in FIG. 1 shows an auxiliary power source being directly fed from the alternating current source 30, which function thereof is to supply the required regulated voltages to maintain the electronic ballast main circuits microcontrollers and integrated circuits fed, that is circuits 40, 50, 70 and 80.

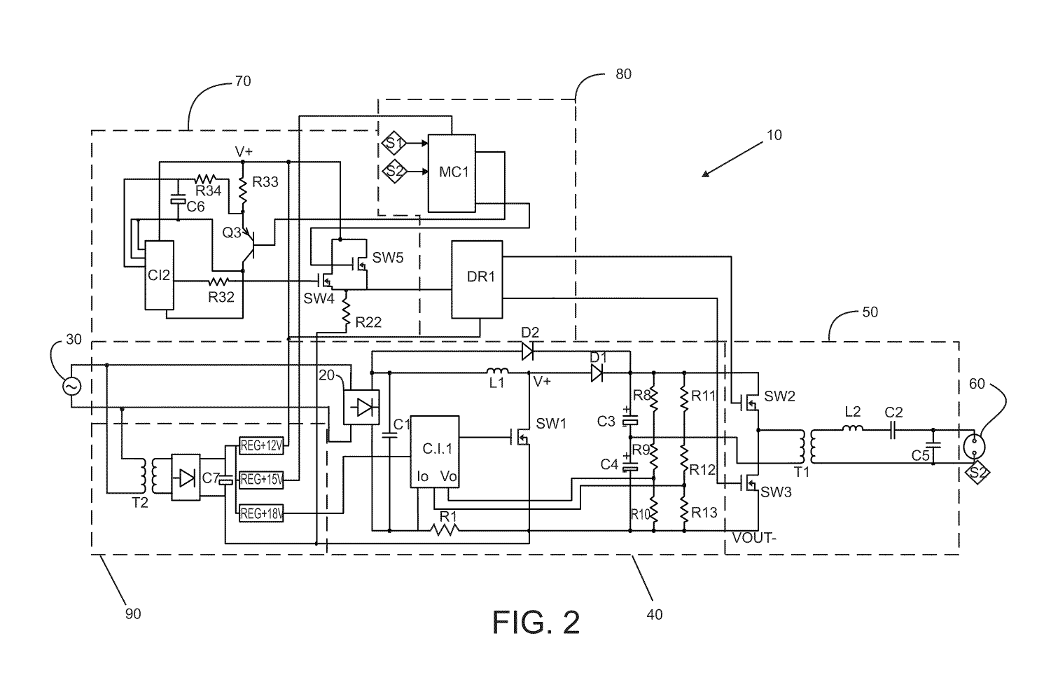

Now, reference will be made to FIG. 2, illustrating a detailed diagram of the electronic ballast 10 electronic circuits according to the previous figure, the main circuits are enclosed and delimited with a dashed line, excepting the rectifier circuit 20 represented by a block inside the power factor correction circuit 40. In addition to circuits 20 and 40, an alternating current source 30, direct current (DC) to high or low frequency alternating current (AC) converter circuit 50, HID lamp 60, ignition circuit 70 and the control circuit may be noted in FIG. 2.

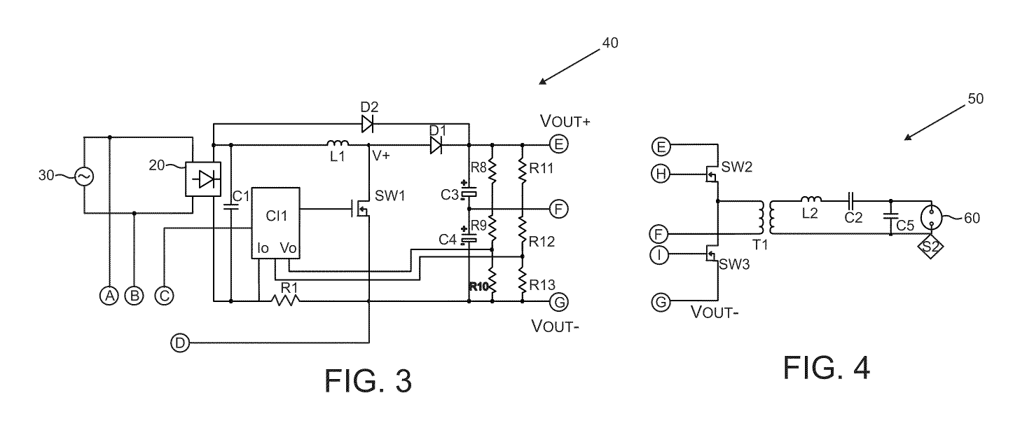

To start describing each circuit of the preferred embodiment ballast being described, firstly reference to FIG. 3 will be made, wherein the alternating current source 30, rectifier circuit 20 and PFC circuit 40 are shown together, from which is to be mentioned that the alternating current source 30 supplies said alternating current to the ballast through public electricity network traditionally at a voltage of 120/220 ACV and a frequency of 60 Hz. The alternating current (AC) is fed on the one hand to the rectifier circuit 20, and on the other hand, it is fed to the auxiliary power source at the interconnection points A and B.

In a preferred manner, the rectifier circuit 20 consists of a full wave rectifier bridge, which topology is widely known for the skilled in the art, and generally is formed by four diodes arranged in such way that, depending on the semi-cycle of the alternating current, the current will be conducted by a pair of diodes and, on the contrary semi-cycle, the other two diodes do the same, achieving a voltage signal at the outlet of the rectifier circuit 20 with all semi-cycles of the same sign (twice the inlet current frequency fed). This rectifier circuit 20 may include fuses to prevent transmission of overcharges and peaks from the alternating current source 30 to the other electronic ballast circuits.

Now then, the power factor correction circuit 40 is mainly detailed in FIG. 3, this circuit obeys to a converter circuit topology of the rising type operating in a continuous conduction mode. The function of the PFC circuit 40 is to convert the low value DC voltage (120/220 volts), in high value DC voltage, e.g., 385 volts by means of the energy storing inductor L1, switch SW1 acting as a high rate switch and diode D1 being series connected to inductor L1, allowing energy release therefrom when the switch SW1 is in a non-conductive state. The triggering of the SW1 switch is commanded by the integrated circuit C11. The PFC circuit 40 operates with a feedback control loop formed by two lines, one of which is taken between the series resistances R9 and R10, and the other one between series resistances R12 and R13, both lines are directed toward the integrated circuit C11, which through the line before the resistance R1, takes as a reference the feed line voltage wave form and commands the triggering of switch SW1 in order to modulate the functioning of the overall circuit 40, thereby achieving the same wave form in the current being consumed from the line, and to be further kept in phase with the voltage.

Based on FIGS. 3 and 4, it can be mentioned that the PFC circuit 40 provides charge to a set of capacitors C3 and C4 series arranged, which stores the energy to be required by the direct current converter circuit (DC) to high or low frequency alternating current (AC) 50 illustrated in FIG. 4 thereby delivering the required power to the lamp 60. In this sense, the PFC circuit 40 is connected to the converter circuit 50 at the interconnection points E, F, G; among these, at point E there is a positive value output voltage, at point G a negative value output voltage and at point F is the connection to the transformer T1 common of the DC to high or low frequency AC converter circuit 50 in FIG. 4, point F is the return point for the HID lamp 60 operation current.

On the other hand, the integrated circuit C11 is energized by the auxiliary power source through the interconnection points C and D, the integrated circuit C11 has other connections but only those required for the understanding of the basic operation of the power factor correction circuit 40 are shown, including also the diode D2 and resistances R8 and R11 which are current dividing resistances to provide the control loop and useful to tune up the operation of the PFC circuit 40. Finally, the capacitor C1 can be noted in FIG. 3, which functions as a high frequency filter.

It is to mention that in an alternative embodiment of the ballast of the present invention, the power factor correction circuit PFC 40 can be substituted by a filter directly connected to the rectifier circuit 20 and having an essential minimum filter value, this filter allows offering a good power factor with a minimum of overall harmonic distortion, excellent power factor and overall harmonic distortion values are obtained in this embodiment, besides reducing the ballast costs.

Now, the diagram for the direct current to high or low frequency alternating current converter circuit 50 is specially shown in FIG. 4, this circuit 50 is in charge of directly supplying the energy towards the lamp 60. The converter circuit 50 receives energy from the PFC circuit 40 through the interconnection points E and G and it is further interconnected to the control circuit 80 (see FIG. 2) at the interconnection points H and I. The converter circuit 50 topology obeys to a quasi-resonant middle bridge configuration and it has the high frequency switches (MOSFET transistors) SW2 and SW3 as components operating in switching mode at zero voltage. The conduction state of the switches SW2 and SW3 is commanded by the control circuit, in a particular manner, at the interconnection point H a high gate signal is received for switch SW2, and at the interconnection point I a low gate signal is received for switch SW3. This feature allows, on the one hand, to operate at low energy losses originated by the of switches SW2 and SW3, and on the other hand, by varying the frequency of switches SW2 and SW3, the power variation is achieved, which is then delivered to the lamp 60, and accordingly, the luminous intensity control thereof is reached. Precisely, at taking advantage of this switching feature by the control circuit, the ballast can carry out the energy savings, which is very valuable on lighting systems, preferably the public lighting systems.

Switches SW2 and SW3 continuously conduct electricity producing a square wave at the intersection being connected to transformer T1, which common is returned to the PFC circuit 40 at the point F. After the transformer T1, the current is converted into a sinusoidal form by a resonant circuit LCC formed by the inductor L2, capacitor C2 and capacitor C5, the operation frequency of the resonant circuit formed by L2, C2 and C5 is always higher than its resonance frequency. It is important to point out that the lamp 60 turning on is sensed by the sensor S2 located in operative communication with the control circuit.

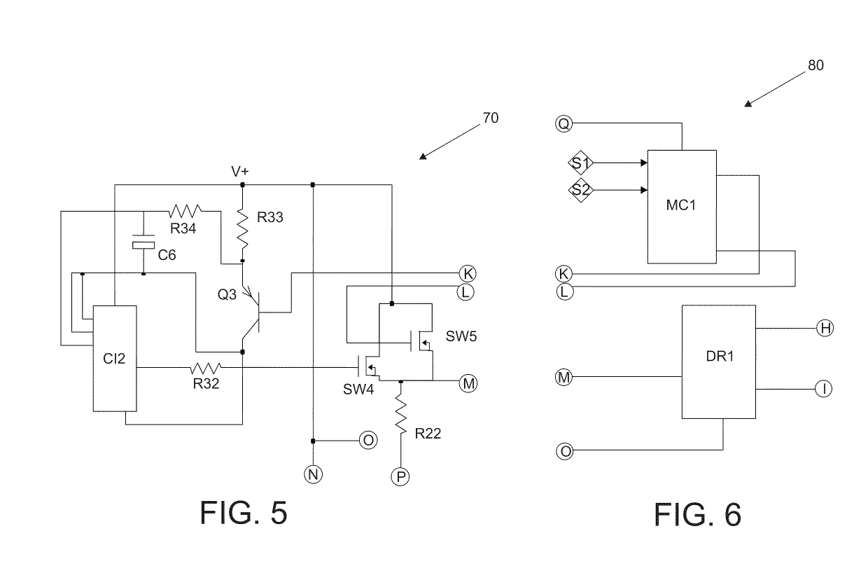

The ignition circuit 70 and the control circuit 80 will be now described with reference to FIGS. 5 and 6. Firstly, it is to be mentioned that the ignition circuit 70 is interconnected to the control circuit 80 at interconnection points K, L and M in order to receive and send signals, furthermore, to receive regulated energy from the auxiliary power source at points N and P. On the other hand, the control circuit 80 is interconnected to the converter circuit at interconnection points H and I, which as noted above, command the triggering of the converter circuit high frequency switches SW2 and SW3. Further, the control circuit 80 receives regulated energy from the auxiliary power source at Q and O points, this latest interconnection point is a derivation of the feed supplied to the ignition circuit 70 provided at point N.

Once having identified the main circuit connections in FIGS. 4 and 5, it can be mentioned that the ignition circuit 70 provides two resonant frequencies which are transmitted to the converter circuit 50 through actuator DR1 in the interconnection points H and I. The first resonance frequency has a value between about 1.5 and 7 times higher with respect to the value of the second resonance frequency. The higher resonance frequency is referred to as starting or ignition frequency and the second frequency is referred to as operation resonance. At the first frequency, the voltage gain achieved in the converter circuit 50 is high enough as to ensure the lamp to be easily turned on, while at the second resonance frequency, the ballast operates always at a higher frequency at which the acoustic resonance phenomena occurs, as for example, in conventional sodium steam lamps.

With regard to the above, the ignition circuit 70 executes a characteristic turning on method of the HID lamp in a reliable, quick and efficient manner, specifically, the integrated circuit C12, which is an oscillator of the VCO type (Voltage Controlled Oscillator) of the ignition circuit 70, carries out a downward frequencies scan, consisting of generating frequencies at a range comprised from a frequency higher to the lamp ignition frequency up to a heating frequency thereof, at a nominal power fraction of the lamp. The frequencies scan is made at this frequencies range, at a time to ensure the reliable starting of the lamp.

More particularly, the scan rate is determined according to the minimum time required to ignite the lamp, so as with said downward scan the integrated circuit C12 of the ignition circuit computes a maximum value in KHz/sec at the downward frequencies scan rate that guaranties the minimum time required for the lamp ignition, at the maximum voltage produced by the ignition circuit.

One advantage achieved by the ignition circuit 70 is that a naturally form protection is provided to the lamp, since the frequency scan boundaries are located at separated regions from the maximum generation of applied voltage occurs; accordingly, the turning on is then optimal. From another point of view, the turning on voltage is gradually increased up to the ignition value required by the lamp, and no more. The downward scan covers a very wide frequency range, at a change rate such that it is ensured the resonant circuit formed by L2, C2 and C5 will pass on the starting frequency and will safely turn the lamp on, the downward frequencies scan ends at a frequency value that, in case the lamp has not turned on, the circuit gain is as low that the high voltage pulses stop and therefore, the risk to damage the converter circuit as well. An example of how the frequencies scan is carried out for a particular case will be described later on this description.

As mentioned above, the ignition circuit 70 is fed from the auxiliary power source at points N and P, among these, point N has a positive voltage, and point P a negative voltage or zero volts, and it is connected to the resistance R22, which at the same time is connected to the high frequency switches SW4 and SW5, which together form a high speed selector, since they receive both the downward frequencies scan generated by the integrated circuit C12 of the ignition circuit 70, and the power profile stored in the programmable microcontroller MC1 of the control circuit 80, such power profile is stored as a frequencies profile.

The optic sensor S2 detects when the lamp has turned on, and the programmable microcontroller MC1 of the control circuit 80 uses a control frequency through a command thereof transmitted towards the selector (switches SW4 and SW5), disabling, therefore, the downward frequencies scan and from that moment controls the power supplied to the lamp, according to a power profile previously programmed. Control circuit 80 incorporates a luminous optic sensor S1 detecting the environment dark extent, when said sensor S1 detects that the night is to fall, the control circuit 80 commands the ignition circuit 70 to execute the downward frequencies scan explained above. This sensor S1 is preferably a solid state optic sensor. The solid state luminous sensor embodies an important improvement in respect to the detection means used in the prior art ballasts, this sensor is part of the control circuit and it is very reliable.

Moreover, as mentioned above, the control circuit 80 embodies the optic sensor S2, which sends a feedback signal to the microcontroller MC1 to know if the lamp has turned on, if the optic sensor S2 detects that the lamp has not turned on, the control circuit 80 commands to the ignition circuit 70 to retry the turning on, preferably three times, with fixed periods of time between one retry and the other. If the turning on of the lamp is not achieved, it is considered that it is damaged, and this will be announced by an indicator comprised within the control circuit, which will serve, therefore, as a diagnosis. From this moment, the control circuit 80 will not try again to turn the lamp on until the replacement thereof, and the state of the ballast has been recognized by a pulsator in the control. Other remaining ignition circuit components are the capacitor C6, resistance R34 series connected to transistor Q3 which is preferably a bipolar transistor. These components define the scan time. R33 has the function of preparing the scan circuit for a new ignition once Q3 is turned off by a command in point K. At the ignition circuit also is also located the resistance R32, through which the frequency scan is coupled to switch SW4.

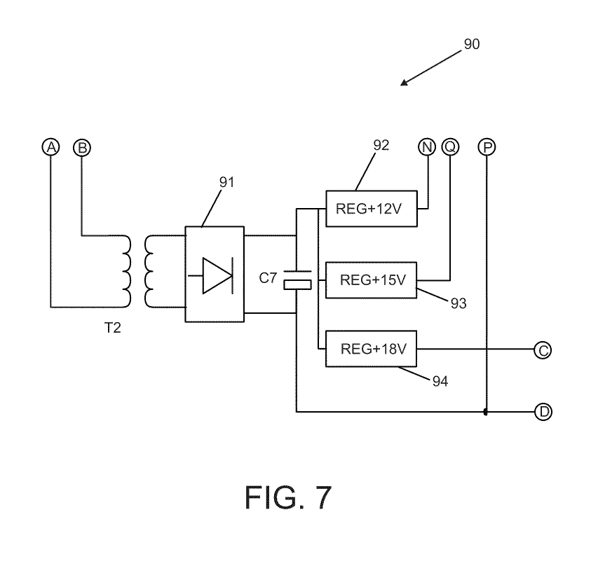

Now, reference is made to FIG. 7, showing the circuit topology through which the auxiliary power source 90 works. This circuit includes transformer T2 being directly connected to the alternating current source at the interconnection points A and B. The auxiliary power source is also connected to the power factor correction circuit at points C and D, to the ignition circuit at points N and P and to the control circuit at point Q. The circuit of the auxiliary power source 90 includes a rectifying bridge 91 such as that described for the rectifier circuit 20, and a capacitor C7 serving as a filter.

The auxiliary power source 90 further comprises three regulators 92, 93 and 94, the first regulator provides regulated voltage of 12 volts being fed through point N to the ignition circuit and which is further transmitted to the control circuit. The second regulator 93 provides a regulator voltage of 15 volts, which is directly feed to the microcontroller MC1 of the control circuit 80. Finally, the third regulator 94 provides regulated voltage to the integrated circuit CI1 of the power factor correction circuit 50. The auxiliary power source supplies energy for the suitable functioning of the integrated circuits, microcontrollers and actuators of the main circuits integrating the ballast at the required time.

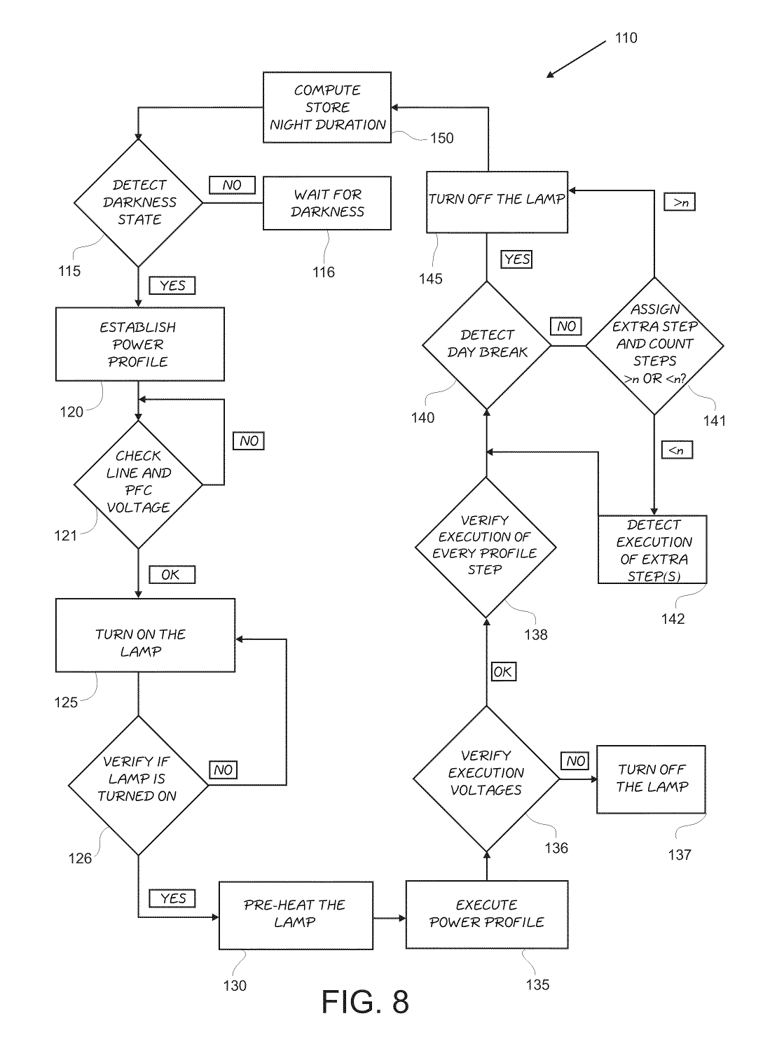

On the other hand, now reference to FIG. 8 will be made, wherein a flowchart is shown, which explains a preferred embodiment of the operation method 110 of the ballast of the present invention, firstly, the method has step 115 wherein the darkness state is detected where the night begins, in the case it is not detected, the method 110 waits for said condition in the additional step 116.

When darkness has arrived, the method carries out step 120, wherein a power profile to be supplied by the ballast to the HID lamp during the night is established. The power profile comprises a set of power steps, each one having a power value the ballast have to supply to the HID lamp as well as a duration time which, as an specific embodiment, can be re-computed with the duration data of at least one previous night; particularly it is preferred the method to take values from 5 previous nights to compute the power profile to be executed.

Once the power profile has been established at step 120, within the method the line and the ballast PFC power correction circuit voltages are checked in step 121, if the voltages are correct, the method 110 executes the turning on step 125, which as previously mentioned, is carried out by a downward frequencies scan, made from a frequency higher than the lamp ignition frequency up to a heating frequency thereof at a nominal power fraction of the lamp. Further, in step 126, it is verified if the lamp is turned on, in case this has not happened, a retry to turn on the lamp is made in step 125. When the lamp has turned on, the step 130 is executed wherein the lamp is gradually pre-heated. Later, in step 135 each power steps established in the profile computed in step 120 is executed. The profile execution step 135 is carried out during nighttime, continually verifying the voltage during step 136, if the voltages are out a preset range, the lamp is turned off in step 137. The power profile consists in the division of the average night duration in a determined number of power steps or segments, wherein a light intensity attenuator is to be applied, reducing the energy consumption according to the attenuation of the power delivered by the ballast in the corresponding step. Moreover, the intensity will be higher during lengths near nightfall and daybreak, and it will be lower during night inter-lengths. The transition from one power profile step and the other is preferably gradually carried out.

Turning to FIG. 8, in step 138, the execution of every power profile step is verified, and if in step 140 the daybreak is detected, the lamp turns off in step 145. Finally in step 150, the night duration is computed for the computed value be stored and may be considered to re-compute the duration of the profile steps the ballast has to execute the following night.

It is very important to mention that in the method 110 embodiment being described, the execution of at least an additional power step is considered for the lamp to comply with its lightning function. Particularly, if in step 140 it is detected that it is not the daybreak, in step 141 at least one extra step is assigned, if necessary, and all steps are counted, it is to say, the power profile steps and the additional one, if an allowed number “n” of steps has been exceeded, then the lamp is turned off in step 145, or if it is lower, the extra step is carried out, the execution thereof is detected in step 142. In said step 142, the luminous optic sensor failure is commanded if the extra step has been carried out and the daybreak has not been detected. After executing the extra power step in 142, the step 140 is executed again to detect the daybreak and the method 110 continues with the turning off of the lamp in step 145.

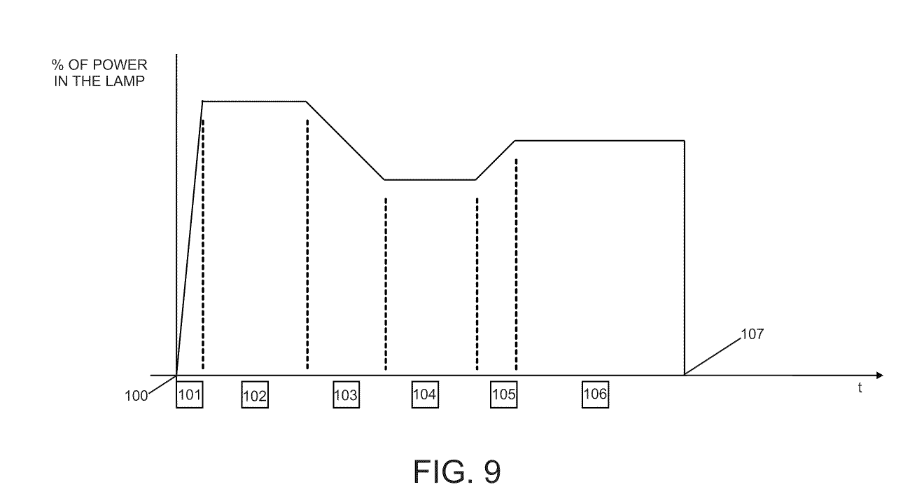

Now, reference is made to FIG. 9, showing a typical power profile curve supplied by the ballast of the preferred embodiment in an HID lamp during time (t) of one night, during which the lamp is functioning, preferably a public lightning system lamp. Point 100 represents the darkness state detected by the optic sensor, thereby the control system commands the lamp turning on or ignition. Once the lamp has been turned on, the control circuit executes the power profile to save energy, starting at step 101 being the lamp heating step, carried out with a power gradual increase, so no overcharge results thereon. This soft starting in step 101 has the additional advantage to achieve lengthening the useful life of the lamp, since the maximum current specified by the lamp manufacturer is never overcame.

Further, in step 102, covering the first hours of the night, the lamp operates at full power or at any other starting value. Then, in step 103, the ballast makes a gradual reduction on the power supplied to the lamp during a percentage of the nighttime, for this, the control system uses the DIMMING. In the next step, being step 104, the lamp operates at reduced capacity, however, the ballast operates said lamp for this to achieve an acceptable lightning level, this step can be executed when people and vehicle transit is very reduced for a determined period of time.

In step 105, the power supplied to the lamp is again gradually increased, but not to a full lightning. In step 106, the lamp may operate for a determined period of time at a power fraction, i.e., this step can be executed during some hours before daybreak. Finally, point 107 represents the moment when the luminous optic sensor detects the daybreak, whereby the control circuit commands the turning off of the lamp.

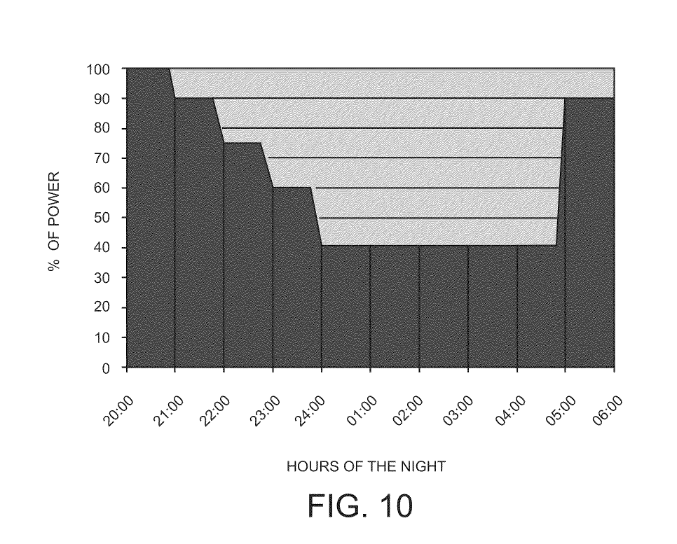

In FIG. 10, a plot showing the power supplied by a ballast through the night divided in hours is shown, where at the beginning of the night (20:00 hours) the ballast supplies 100% of power, and gradually decreases it between one hour at night and the next until midnight, wherein only 40% of power is delivered to the lamp and keeps it for 5 more hours, later, the ballast increases the power to 90% percentage during one hour before daybreak (6:00 hours) when the lamp is turned off.

The ballast of the present invention, may operate the lamp from 30% to 100% of its nominal capacity, and since the microcontroller is programmable, the consumption of the lamp can be controlled at a desired value and executing each profile step for the required period of time. The quantity of options to execute the power profile to save energy based on the ballast of the present invention is, indeed, unlimited, and enables all energy saving to be applied in public and private lightning, according to the particular consumer's needs.

In a preferred embodiment of the present invention, the control circuit microcontroller has the auto-adaptability capacity, this means, it determines the duration of each night between the lamp turning on and turning off, in this manner learning, and distributing in an automatic manner the programmed schedules of the steps to be executed in the following night. As the microcontroller includes a non-flash memory, the data are safe. Then, the ballast can be used at all earth latitudes in this manner, without lowering its energy saving capacity.

With regard to the above, this auto-adaptability or learning capacity is adequate to high latitudes wherein the night seasonal length varies considerably. In other embodiment, the microcontroller is programmed with fixed times for the execution of the power profile steps and it is useful at low latitudes, wherein the night duration does not vary considerable along the year.

In an additional embodiment, the ballast comprises communication means such as antennas or infrared sensors to receive external signals to operate and program the ballast from an external controller, this embodiment is very useful in some places such as industrial facilities having a control room.

The electronic ballast for high intensity discharge lamps of the present invention, and in particular, its downward scan method will be clearly illustrated by means of the following example, which is set for illustrative purposes, therefore being not limitative of the present invention.

### EXAMPLE

Frequencies Scan Example

This example makes reference again to FIG. 4, wherein for a particular case L2=134 uH and C2=120 nF, the gain curve of the ignition resonant circuit, formed by T1, L2 and C5, has a maximum gain of 42.5 dB, and for a safe turning on of the lamp, 28 dB are required. These values give a resulting band width for the ignition curve of about 3 KHz. The scan time for these 3 KHz must be enough for the lamp to respond and turn on in 1 ms, which is time enough. The frequencies scan is provided by an ignition circuit 70 in FIG. 5, by means of Q3, C6 and R34 components, together with the oscillator of the VCO type (C12). Specifically, Q3 discharges the capacitor C6 providing a voltage decreasing as exponential discharge. The resulting voltage is fed to C12, and this generates the scan in the frequencies range required for the ignition. In this case, Q3 is a bipolar transistor of the MPS2907A type, R34 is of 10 KΩ and C6 is of 1 μF, of course, this ballast features may change according to the ballast design. Once the lamp is turned on, the control circuit operates the lamp according to the power profile in FIG. 9 or FIG. 10, explained above.

According to the above description, it may be seen that the electronic ballast of the present invention has been conceived to deliver the power to the lamp according to a preset profile, achieving an energy saving; and it will be obvious to one skilled in the art that the above described embodiment is only illustrative and non-limitative of the present invention, since many consideration changes in its details are possible with departing from the scope of the invention, as may be the execution times for each profile steps, as well as the power developed by the lamp in each step of the profile and the topology of each main circuit of the ballast.

Although a preferred embodiment of the invention has been described and exemplified, it should be emphasized that numerous modifications thereof are possible. Therefore, the present invention shall not be considered as constrained except for the prior art and the scope of the appended claims.

1. An electronic ballast for a high intensity discharge lamp, of the type comprising: (a) a rectifier circuit receiving alternating current (AC) from an alternating current source and converts it to direct current (DC); (b) a power factor correction circuit increasing the direct current voltage (DC) coming out from said rectifier circuit and reducing the overall harmonic distortion; y, (c) a current converter circuit receiving high voltage direct current (DC) coming out from the power factor correction circuit and converts it to high or low frequency alternating current (AC), which is supplied to said high intensity discharge lamp;
said ballast being characterized in that it comprises additionally:
d) an ignition circuit generating ignition pulses being fed to the current converter circuit to turn on the lamp, the ignition pulses being generated according to a downward frequencies scan; and,
e) a control circuit connected to the ignition circuit and to the converter circuit, wherein said control circuit commands the operation of the ignition circuit to turn on the lamp and controls the power being supplied to the lamp from its turning on to its turning off according to a power profile stored in said control circuit and determined by the lightning conditions a user desires to obtain from said lamp in order to save energy.

2. An electronic ballast for a high intensity discharge lamp, according to claim 1, further characterized in that the downward frequencies scan is carried out from a frequency higher than the ignition frequency of the lamp up to a heating frequency thereof.

3. An electronic ballast for a high intensity discharge lamp, according to claim 2, further characterized in that said downward frequencies scan is carried out at a nominal power fraction of the lamp.

4. An electronic ballast for a high intensity discharge lamp, according to claim 2, further characterized in that the rate at which said downward frequencies scan is carried out is determined based on the minimum time required for the lamp ignition, such that a maximum value in KHz/sec is obtained at the downward frequencies scan rate which guarantees the minimum time required for the lamp ignition.

5. An electronic ballast for a high intensity discharge lamp, according to claim 1, further characterized in that the resonant circuit provides two resonance frequencies in the converter circuit, the first being an ignition frequency and the second an operation frequency, wherein the ignition frequency is always higher than the operation frequency.

6. An electronic ballast for a high intensity discharge lamp, according to claim 1, further characterized in that the control circuit includes a sensor to detect if the lamp has been turned on, in case the lamp has not been turned on, the control circuit commands the ignition circuit to carry out retries to turn on the lamp.

7. An electronic ballast for a high intensity discharge lamp, according to claim 6, further characterized in that the retries to turn on the lamp are carried out at fixed periods of time between one retry and another until said ignition circuit makes a maximum number of retries.

8. An electronic ballast for a high intensity discharge lamp, according to claim 7, further characterized in that the control circuit comprises an indicator activated in case the lamp has not turned on in said maximum number of retries.

9. An electronic ballast for a high intensity discharge lamp, according to claim 1, further characterized in that the downward frequencies scan generated by said ignition circuit and the power profile stored in the control circuit are fed to a high speed selector, wherein, when the lamp is turned on, the control circuit uses a control frequency through a command thereof which is transmitted to the selector to disable the downward frequencies scan.

10. An electronic ballast for a high intensity discharge lamp, according to claim 1, further characterized in that the control circuit includes a luminous optic sensor detecting the environment darkness extent to command the turning on of the lamp to the ignition circuit.

11. An electronic ballast for a high intensity discharge lamp, according to claim 10, further characterized in that the luminous optic sensor is a solid state optic sensor.

12. An electronic ballast for a high intensity discharge lamp, according to claim 1, further characterized in that the ballast operates public lightning networks lamps working at night.

13. An electronic ballast for a high intensity discharge lamp, according to claim 1, further characterized in that the power profile is integrated by a series of steps, in each step the ballast delivers to the lamp a higher or lower power which duration does not vary from one night to the following.

14. An electronic ballast for a high intensity discharge lamp, according to claim 1, further characterized in that said control circuit includes a programmable microcontroller with a non-flash memory wherein the functioning time data are stored, as well as the lamp power from its turning on to its turning off in one night, said microcontroller automatically adjusting the duration of each power profile steps to be carried out the following night.

15. An electronic ballast for a high intensity discharge lamp, according to claim 1, further characterized in that the ballast comprises communication means receiving external signals to operate and program the ballast from an external controller.

16. An electronic ballast for a high intensity discharge lamp, according to claim 1, further characterized in that it comprises additionally an auxiliary power source supplying a regulated voltage to circuits (b) to (d).

17. An electronic ballast for a high intensity discharge lamp, according to claim 1, further characterized in that the power factor correction circuit is substituted by a filter directly connected to the rectifier circuit and having an indispensable minimum filter value.

18. An electronic ballast for a high intensity discharge lamp, according to claim 1, further characterized in that the ballast operates the lamp from a 30% to a 100% of its nominal capacity.

19. A method for operating a ballast as claimed in claim 1, the operation method being characterized in that it comprises the steps of:
a) detecting the darkness state where the night begins;
b) establishing a power profile to be supplied by the ballast towards the lamp during nighttime; the power profile comprising a series of power steps, each having a power value the ballast has to supply to the lamp, as well as a period of time which can be re-computed with the duration data of at least one previous night;
c) turning on the lamp by a downward frequencies scan, the downward scan being carried out from a frequency higher than the ignition frequency of the lamp up to a heating frequency thereof;
d) pre-heating the lamp;
e) executing the power profile steps;
f) verifying the execution of the power profile steps;
g) detecting the daybreak;
h) turning off the lamp; and,
i) computing the night duration in order that the computed value be stored and considered to re-compute the duration of the profile steps the ballast has to execute the following night.

20. A method to operate a ballast, according to claim 19, further characterized in that in step (b) the method takes the values from 5 previous nights to compute the power profile to be executed.

21. A method to operate a ballast, according to claim 19, further characterized in that it comprises carrying out at least one extra power step in case of having executed all the profile steps and it is not the daybreak.

22. A method to operate a ballast, according to claim 21, further characterized in that in case one of the extra step has already been executed, and it is detected that it is not the daybreak yet, the method commands the ballast luminous optic sensor failure.

23. A method to operate a ballast, according to claim 19, further characterized in that the frequencies scan is carried out at a nominal power fraction of the lamp.

24. A method to operate a ballast, according to claim 19, further characterized in that in case the lamp has not turned on in step (c), attempts to restart the lamp are made.

25. A method to operate a ballast, according to claim 19, further characterized in that the transition between one power profile step and another is gradually carried out.
